(19) United States
(12) Patent Application Publication
(10) Pub. No.: US 2026/0077686 A1
(43) Pub. Date: Mar. 19, 2026

(54) SPUR GEAR TRANSMISSION AND TRANSMISSION DRIVE UNIT FOR ADJUSTING MOVING PARTS IN A VEHICLE

(71) Applicant: Robert Bosch GmbH, Stuttgart (DE)

(72) Inventors: Andreas Meier, Buehl-Eisental (DE); Anja Burger, Buehl (DE); Joerg Schmid, Achern (DE); Klaus Wohlschlegel, Neuried-Altenheim (DE)

(21) Appl. No.: 19/330,028

(22) Filed: Sep. 16, 2025

(30) Foreign Application Priority Data
Sep. 17, 2024 (DE) 10 2024 208 861.7

(51) Int. Cl. B60N 2/02; B62D 1/181

(52) U.S. Cl. CPC B60N 2/02253; B62D 1/181

(57) ABSTRACT

The invention relates to a spur gear transmission (10) and a transmission drive unit (11) for adjusting movable parts (12) in a vehicle, in particular seat components or a steering column, having a first gear stage (21), consisting of a worm (20) and a worm wheel (22) meshing with the worm (20), and having a second gear stage (31), consisting of a first spur gear (30) and a second spur gear (32) meshing with the first spur gear (30), wherein the worm wheel (22) is rotationally fixedly connected to the first spur gear (30) via a common axis of rotation (42), and the second spur gear (32) has a hollow shaft (51) with an inner profile (52) as an output element (50), and both gear stages (21, 31) are supported in a common gear housing (18), and the second spur gear (32) is made of plastic, by means of which an output torque greater than 25 Nm can be transmitted over the long term without damage.

### BACKGROUND

The invention relates to a spur gear transmission and to a transmission drive unit for adjusting moving parts in a vehicle.

DE 10 2013 106 686 A1 describes a gear for use in transmission drive units in the motor vehicle made from a metal material by sintering. In order to achieve sufficient mechanical load capacity, it is proposed to replace previously used plastic gears in worm gears and spur gears with the sintered gear. This gear has a so-called crowning and/or a coating which reduces the wear and noise of the gear. The sintering operation made of metal is more cost-efficient than manufacturing the gear from metal by machining. However, such a metallic sinter material is still relatively expensive and heavy. These disadvantages are to be rectified by the solution according to the invention.

### SUMMARY

In contrast, the spur gear according to the invention with the features of the disclosure has the advantage that the two-stage transmission can be manufactured from plastic and can still receive torques of up to 30 Nm over its entire service life. A second spur gear stage is then arranged after a first worm gear stage, the second spur gear stage of which is mechanically configured as a plastic second spur gear such that it can also be permanently loaded with torques greater than 25 Nm. This allows the transmission drive unit to be manufactured more easily and cost effectively without increasing its design space. The multi-stage transmission device according to the invention offers particular advantages due to its very compact design in conjunction with relatively high, transferable torques. This allows the use of compact and lightweight electric drives.

The mechanical stability of the second spur gear may be increased by the radially outer region of the spur gear teeth being formed axially longer than a radially inner hub region on which the hollow shaft is formed as an output element. The radially outer sprocket is supported by radial ribs in the hub region, wherein the axial extension of the radial ribs in the axial direction is greater in the radial region of the spur gear teeth than in the radially inner hub region, causing the end face of the radial ribs to slope downwards from the outside to the inside.

It may be particularly advantageous to integrate a hollow shaft with an inner profile into the second spur gear as an output element, which is preferably manufactured monolithically with the spur gear made of plastic. Bearing journals extend from a radially inner hub region of the spur gear on both axial sides, which are received in corresponding bearing receptacles of the gear housing. The bearing receptacles can be configured as round through-holes in the gear housing in which the two bearing journals are mounted so that they can rotate directly.

The bearing receptacle in the cover of the gear housing can advantageously be configured in a truncated cone-shaped bearing region of the gear cover, such that the truncated cone of the gear housing cover axially engages a cavity that is formed radially within the second spur gear teeth keying by the beveled radial ribs. As a result, the hollow shaft can be particularly favorably supported to a large extent in an axial region of the gear housing, which axially overlaps with the second spur gear teeth. This allows a spur gear with a very flat axial design to be manufactured for relatively high torques.

In order to mechanically stabilize the second spur gear, a parallel support wall is formed concentrically within the outer sprocket, which is connected to the outer sprocket via support webs. A radially outer double wall is thereby formed to prevent radial compression of the spur gear teeth. The support webs preferably run in the radial direction, but can also form an angle to the radial direction. The axial end faces of the support webs towards the gear housing cover can be designed to slope inward toward the inner hub area, and in particular can form a common slope with the sloping radial ribs that are formed radially inside the support wall.

The gear housing has an internal axial clearance over a substantial angular range of the second spur gear in its interior that is substantially as large as the axial extension of the second spur gear teeth of the second spur gear. This radially outer spur gear teeth are configured longer in the axial direction than the axial extension of the hub region radially inside the second spur gear. For example, the axial extension of the spur gear teeth is greater than the axial extension of the hub region by a factor of 1.2-1.5. The hub region is particularly favorably positioned in the axial direction on a radially inner support ring, which also forms the circumferential wall of the bearing mount in the gear housing for the hollow shaft.

To achieve optimum torque transmission, the spur gear teeth of the first spur gear engage with the second spur gear teeth over the entire axial extension of the second spur gear. In particular, the first and the second spur gear teeth extend axially upward to the same distance to the inside of the gear cover. The first spur gear can be manufactured inexpensively together with the worm wheel as a common monolithic injection molded part made of plastic or as a steel spur gear combined with an injection molded worm wheel made of plastic. Preferably, this component is rotatably arranged on a bearing shaft, which is attached in the gear housing in a rotationally fixed manner.

The helical teeth of the second spur gear, which meshes with corresponding helical teeth of the first spur gear, has proven to be particularly robust mechanically. The second spur gear teeth between the teeth has elliptical roundings in the base area of each tooth, which reduce notch stress on the individual teeth.

To optimize the meshing properties of the second spur gear and to directly mount its bearing journals in the gear housing, the second spur gear is made of POM plastic, in particular highly viscous nucleated POM-H, and is injection molded in one piece. This prevents disruptive noises and ensures that wear on the rubbing areas is designed to match the service life of the spur gear.

The hollow shaft may be manufactured particularly cost-effectively from plastic with a completely continuous internal profile. This conserves further material and weight while providing an output interface on both sides of the second spur gear. Thus, a continuous profile shaft can also be inserted into the hollow shaft profile, which can simultaneously adjust a movable part at its two free ends. Alternatively, depending on the design space, the profile shaft can be inserted into the hollow shaft of the second spur gear from either axial side. For example, the free ends of a continuous profile shaft directly engage with a receptacle in a seat joint, such that, for example, the backrest can be tilted relative to the seating surface. The hollow shaft profile can be formed as a square profile or as a hexagon profile or as a Torx or as an internal multi-tooth profile during injection molding of plastic without additional cost. A sufficiently good positive seal is thus achieved for the profile shaft in the plastic component for torque transfer. In addition, this means that no installation space is required axially outside the hollow shaft for connecting the flexible shaft.

In order to realize as compact a gear drive unit as possible, the worm is arranged directly on an integral rotor shaft of the electric motor. The two gear stages deflect the output torque at approximately right angles, so that the axis of rotation of the hollow shaft as the output element is aligned transversely to the rotor shaft. The electric motor is flanged directly to the gear housing via a flange on the stator housing, with the continuous rotor shaft and the worm mounted on it protruding into the gear housing. The rotor shaft is supported on a closed bottom of the stator housing and on an opposite bearing blade in the area of the flange, such that the rotor shaft projects into the first screw gear stage with a free end.

### BRIEF DESCRIPTION OF THE DRAWINGS

Further advantages and expedient embodiments can be found in the claims, description of the figure and the drawings. Shown are:

FIG. 1 a perspective view of a transmission drive unit according to the present invention,

FIG. 2 a sectional view of the transmission drive unit according to FIG. 1, and

FIG. 3 a further embodiment of a seat back adjustment unit.

### DETAILED DESCRIPTION

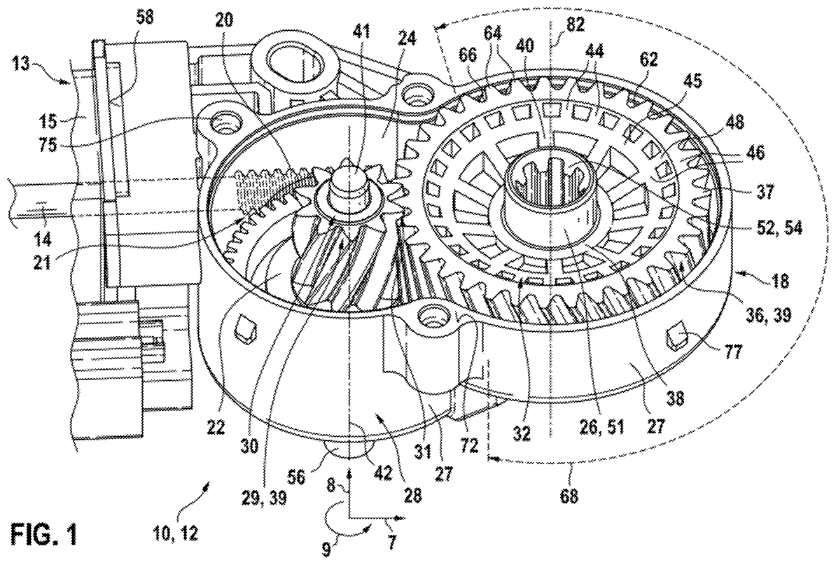

FIG. 1 shows a transmission drive unit 12 used to adjust a moving part in a vehicle, for example to adjust seat components (88), or a steering column. The transmission drive unit 12 includes a spur gear 10 having a first gear train 21 configured as a worm gear and a second stage 31 configured as a spur gear 10. The first gear stage 21 comprises a worm 20, which is connected here in a rotationally fixed manner to a rotor shaft 14 of an electric motor 13, and a worm wheel 22 that engages with the worm 20. A first axis of rotation 42 of the worm wheel 22 is arranged approximately perpendicular to the axis of the worm 20 and thus also approximately perpendicular to the rotor shaft 14. A first spur gear 30 of the second gear stage 31 is arranged on the common first axis of rotation 42 with the worm wheel 22. The worm wheel 22 and the first spur gear 30 are arranged rotationally fixed to one another on a common shaft 41, which is supported in the gear housing 18. The first spur gear 30 meshes with a second spur gear 32 of the second gear stage 31, whose second axis of rotation 82 is aligned approximately parallel to the first axis of rotation 42. The second spur gear 32 is arranged rotationally fixed on a hollow shaft 51, which is rotatably supported in bearing receptacles 16 of the gear housing 18. The second spur gear 32 is formed integrally—i.e., monolithically—with the hollow shaft 51 made of plastic. Preferably, the plastic material is POM—in particular a high viscosity nucleated POM-H. The hollow shaft 51 is designed on both sides as opposing bearing journals 26 on a radially inner hub region 38 of the second spur gear 32, which engage axially directly in the bearing receptacles 16 of the gear housing 18. The gear housing 18 is preferably also formed from plastic, wherein a lower housing shell 28 is closed with a gear housing cover 19, the mounting direction of which runs along the common axis of rotation 42 and transversely to the rotor shaft 14. The bearing receptacles 16 are formed here in both the lower housing shell 28 and the gear housing cover 19. In the hollow shaft 51, an inner profile 52 is formed as an output element 50, which is formed as an inner spline 54 in FIG. 1, for example. A longitudinal axis of the inner profile 52 coincides with the second axis of rotation 82 of the hollow shaft 51. Preferably, the inner profile 52 penetrates the hollow shaft 51 on its entire length, such that both the two bearing journals 26 and the second spur gear 32 are completely penetrated by the inner profile 52. This provides an output interface on both axial sides of the second spur gear 32.

In order for the spur gear 10 made of plastic to receive higher torques, elliptical roundings 66 are formed on the second spur gear teeth 36 between their tooth bases 62. As a result, the tooth base stress is reduced and the sprocket 37 with the second spur gear teeth 36 may thereby take up higher torques without damage. In addition, the second spur gear teeth 36 extend in the axial direction 8 approximately over the entire axial extension 33 of the interior 24 of the gear housing 18 in the angular range 68 of the second spur gear 32 in which the latter does not overlap radially with the worm wheel 22. The first spur gear teeth 29 of the first spur gear 30 extend in the axial direction 8 substantially over the entire axial extension 34 of the second spur gear teeth 36. The hub region 38 of the second spur gear 32, on the other hand, has a lower axial extension 35 than the axial extension 34 of the radially outer second spur gear teeth 36 of the sprocket 37. In this case, at least on one axial side 70 facing the gear housing cover 19, inclined radial ribs 40 are formed between the radially outer sprocket 37 and the radially inner hub region 38, the axial dimension of which increases radially outward from the hub region 38 toward the sprocket 37. This creates a ring-shaped cavity in the second spur gear 32 between the bearing journal 26 and the sprocket 37, into which a truncated cone-shaped bearing region 17 of the gear housing cover 19 engages axially. The bearing receptacle 16 for the hollow shaft 51 is centrally formed in the truncated cone-shaped bearing region 17. The slope of the truncated cone-shaped bearing region 17 approximately runs parallel to the axial front face of the angular radial ribs 40 of the second spur gear 32. For mechanical stabilization, the sprocket 37 comprises a double wall 46. The outer sprocket 37 is supported by support webs 44 on a support wall 45 located further radially inward, wherein the support webs 44 in particular also have a bevel 48 in the radial direction 7 toward the hub region 38, at which the bevel of the truncated cone-shaped bearing region 17 of the gear cover 19 is axially opposite. The lower gear housing shell 28 has a flat circumferential surface facing the gear housing cover 19 as a flange 72, on which the gear cover 19 rests and can optionally also be screwed into the flange 72. For this purpose, corresponding holes 75 for connecting screws 74 are configured in the planar flange surface. On the side axially opposite the gear cover 19, the lower gear housing shell 28 has an axial step so that the region in which the worm wheel 22 is mounted has a greater axial extension 23 than the axial extension 34 in the angular area 68 of the second spur gear 32.

In FIG. 1, the spur gear 10 is driven by the electric motor 13, the stator housing 15 of which is connected to the gear housing 18 via a motor flange 58 formed thereon. A rotor body is disposed on the rotor shaft 14 of the electric motor 13 and is wrapped with an electrical coil connected to a commutator disposed on the rotor shaft 14. The electric coil cooperates with permanent magnets disposed in the stator housing 15. The rotor shaft 14 then projects out of the stator housing 15 and into the gear housing 18. The rotor shaft 14 is preferably formed integrally, wherein the worm 20 is arranged in a rotationally fixed manner at the free end of the gear housing 18. As an alternative to this DC motor 13, the spur gear 10 can also be driven by an EC motor 13.

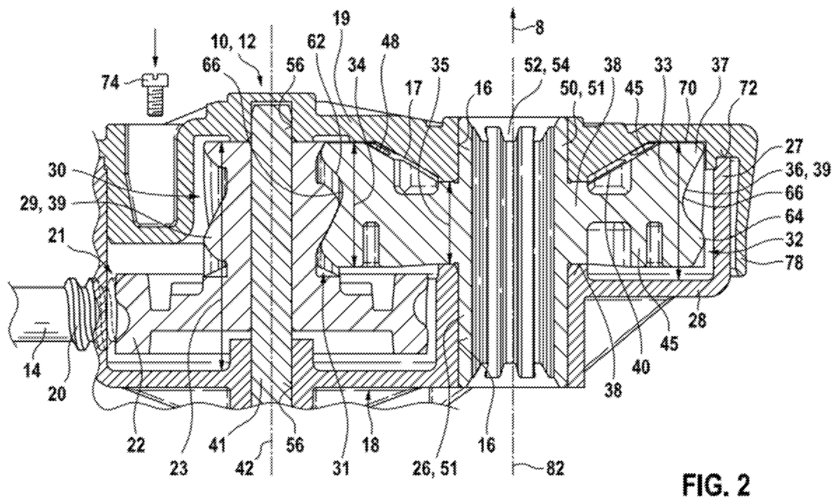

FIG. 2 shows a section through the spur gear 10 according to FIG. 1. On the left side, a cross-section through the worm wheel 22 and the first spur gear 30 is shown, whereby the common shaft 41 is mounted, for example, in a rotationally fixed manner in bearings 56 in the gear housing 18. The monolithic component—consisting of the worm wheel 22 and the first spur gear 30—is then mounted rotatably on the housing-fixed shaft 41. The first spur gear teeth 29 and the second spur gear teeth 36, are configured as meshing helical teeth 39, wherein their engagement area radially overlaps with the worm wheel 22. In FIG. 2, it can be seen that both the first spur gear teeth 29 and the second spur gear teeth 36 extend at the upper axial side 70 towards the gear cover 19 to fully utilize the internal space 24 of the gear housing 18 in the axial direction 8. The second spur gear teeth 36 have a greater axial extension 34 on the axial side 70 towards the gear cover 19 than the axial extension 35 of the hub region 38. The cross-section shows how the front edges of both the support webs 44 and the slanted radial ribs 40 slope in the radial direction 7 from the gear rim 37 toward the hub region 38 at an angle of approximately 20°-40° to the radial plane 7. The truncated cone-shaped bearing region 17 of the gear housing cover 19 engages axially in the resulting cavity radially inside the sprocket 37. As a result, the upper bearing journal 26 of the hollow shaft 51 is rotatably supported in an axially overlapping region with the second spur gear teeth 36 in the bearing receptacle 16 of the gear cover 19. On the opposite axially lower side, the second bearing journal 26 is rotatably mounted in a bearing receptacle 16 of the lower gear housing shell 28. The hollow shaft 51 has an axially continuous inner profile 52, which serves as the output element 50 for the drive unit 12. Instead of the multi-tooth profile 54, the inner profile 52 can also have a multi-edged profile. In the second spur gear teeth 36, the base regions 62 of the teeth 64 are elliptically rounded, which is visible in the longitudinal section of the second spur gear teeth 36 based on the smooth transitions between the adjacent teeth 64. For example, locking elements 77 are molded onto a circumferential wall 27 of the lower gear housing shell 28, into which counter-locking elements 78 engage when the gear cover 19 is pushed on axially. The compact design of the spur gear 10 allows for a very flat drive unit 12, which can also transmit relatively high torques in the range of over 25 Nm without damage.

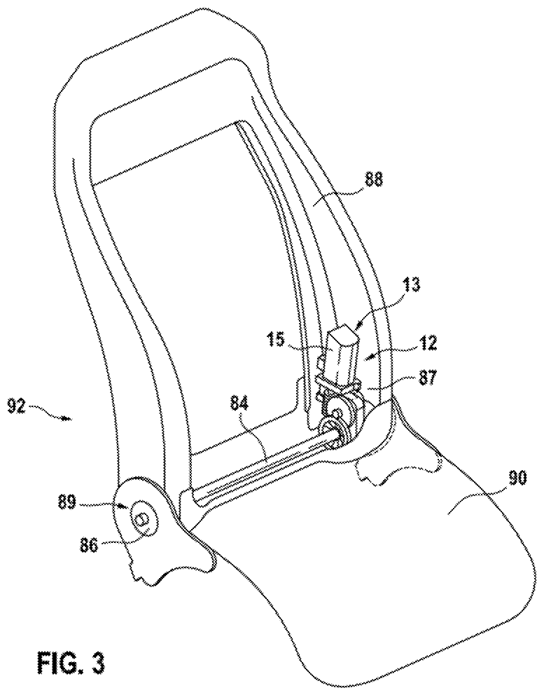

In an exemplary embodiment of a seat adjustment of a vehicle seat 92 illustrated in FIG. 3, two free ends of the profile shafts 84 projecting from the hollow shaft 51 on both sides engage with corresponding shaft receptacles 86 for seat back fittings 87, which form an articulation 89 between a backrest 88 and the seat surface 90. The shaft receptacles 86 are preferably disposed on both sides in respective planetary or eccentric transmissions of the seat back fittings 87 to twist the backrest 88 opposite the seat surface 90. The drive motor 13 with the gear housing 18 is preferably attached to the backrest 88, whereas the shaft receptacles 87 for the profile shafts 84 are attached to the seat surface 90.

In a non-illustrated embodiment of a steering column adjustment, only an axial side of a profile shaft 84 is inserted into the inner profile 52 that projects axially out of the bearing journal 36 of the output gear 50. The torque is transmitted to the parts to be adjusted via a transmission unit using the profile shaft 84, which is positively connected to the output gear 50. The profile shaft 84 can be configured as a flex shaft, for example, or as a pinion, which in particular engage a transmission unit, which is configured as a further gear—preferably a spindle gear or as a rack—on the part to be adjusted. The part to be adjusted can be configured as a steering column, for example, which is adjusted opposite the body.

It should be noted that with regard to the exemplary embodiments shown in the figures and in the description, a wide variety of possible combinations of the individual features with one another is possible. The spur gear 10 described thus far can be altered or modified in many ways without deviating from the idea of the invention. Thus, the design of the electric motor 13 and the torque transmission to the worm 20 and the output interface 50 can be adjusted to the requirements of the adjustment movement and the available construction space. Likewise, the shape and the manner of connection of the lower gear housing 28 and the gear cover 19 may be varied accordingly. The transmission drive unit 12 according to the invention is particularly suitable for the adjustment of movable components in the motor vehicle, in particular for the adjustment of the steering column or seat components.

1. A spur gear (10) for adjusting movable parts in a vehicle, the spur gear (10) having a first gear stage (21), including a worm (20) and a worm wheel (22) meshing with the worm (20), and having a second gear stage (31), including a first spur gear (30) and a second spur gear (32) meshing with the first spur gear (30), wherein the worm wheel (22) is rotationally fixedly connected to the first spur gear (30) on a common axis of rotation (42), and the second spur gear (32) has a hollow shaft (51) with an inner profile (52) as an output element (50), and both gear stages (21, 31) are supported in a common gear housing (18), and the second spur gear (32) is made of plastic such that an output torque greater than 25 Nm can be transmitted without damage.

2. The spur gear (10) according to claim 1, wherein an extension (34) of second spur gear teeth (36) of the second spur gear (32) in an axial direction (8) of the axis of rotation (42) is greater than an axial extension (35) of a radially inward hub region (38) of the second spur gear (32) at least at a first axial side (70) and obliquely extending radial ribs (40) are configured between the hub region (38) and the spur gear teeth (36) with respect to a radial plane (7) supporting a sprocket (37) carrying the spur gear teeth (36) radially opposite the hub region (38).

3. The spur gear (10) according to claim 2, wherein the hollow shaft (51) is arranged radially within the hub region (38), and is configured monolithic with the second spur gear (32) and extends in the axial direction (8) into bearing receptacles (16) in the gear housing (18) on both sides of the hub region (38) beyond the second spur gear (32).

4. The spur gear (10) according to claim 3, wherein the gear housing (18) comprises a truncated cone-shaped bearing region (17) that engages in the sprocket (37) axially along the obliquely extending radial ribs (40), and the bearing receptacle (16) is configured for the hollow shaft (51) in a center of the truncated cone-shaped bearing region (17).

5. The spur gear (10) according to claim 2, wherein the sprocket (37) has a double wall (46) in which the radially outer spur gear teeth (36) are connected via radial webs to a radially spaced supporting wall (45) extending concentrically within the spur gear teeth (36).

6. The spur gear (10) according to claim 21, wherein the radially outer spur gear teeth (36) of the sprocket (37) extend over a certain angular range (68) of the second spur gear (32) substantially over an entire axial extension (33) of an internal space (24) of the gear housing (18) in the certain angular range (68).

7. The spur gear (10) according to claim 2, wherein the first spur gear teeth (29) of the first spur gear (30) extends over the entire axial extension (34) of the radially outer second spur gear teeth (36) of the second spur gear (32).

8. The spur gear (10) according to claim 2, wherein the radially outer spur gear teeth (36) of the sprocket (37) are formed as helical teeth (39), and tooth bases (62) between the teeth (64) are elliptically rounded.

9. The spur gear (10) according to claim 1, wherein the second spur gear (32) is made of POM together with the hollow shaft (51).

10. The spur gear (10) according to claim 1, wherein the inner profile (52) completely penetrates the hollow shaft (51) axially and at least one profile shaft (84) can be inserted axially from both opposite axial directions (8) into the inner profile (52).

11. A transmission drive unit (12) having a spur gear (10) according to claim 1, wherein the worm (20) is arranged on a rotor shaft (14) of an electric motor (13), and the rotor shaft (14) extends approximately perpendicular to the hollow shaft (51) of the second spur gear (22).

12. A seat adjustment device (11), wherein a spur gear (10) according to claim 1 is fixed to a first seat component, wherein at least one profile shaft (84) is connected to the hollow shaft (51) of the second spur gear (32) on the one hand, and on the other hand to a second seat component, whereby the first seat component is motor-adjustable to the second seat component.

13. A steering column adjustment device (11) having a spur gear (10) according to claim 1, wherein at least one profile shaft (84) is on the one hand connected to the hollow shaft (51) of the second spur gear (32) and on the other hand connected to a spindle gear or to a gear rack by which a steering column in the motor vehicle is motor-adjustable relative to the body.

14. The spur gear (10) according to claim 1, wherein the movable parts in the vehicle are seat components (88) or a steering column.

15. The spur gear (10) according to claim 5, wherein the radial webs (44) on ab axial side (70) towards the gear housing cover (19) are also formed at an angle to the radial plane (7).

16. The spur gear (10) according to claim 6, wherein the axial extension (34) of the outer spur gear teeth (36) is at least 1.3 times the axial extension (35) of the radially inner hub region (38).

17. The spur gear (10) according to claim 7, wherein the first spur gear (30) is formed monolithically with the worm wheel (22), which is rotatably arranged on a common shaft (41), and the shaft (41) is supported on both sides in the gear housing (18).

18. The spur gear (10) according to claim 9, wherein the POM material is formed as a high viscosity nucleated POM-H material.

19. The spur gear (10) according to claim 10, wherein the inner profile (52) is configured as a square profile or a hex profile or a Torx or an inner multi-tooth profile (54).

20. The transmission drive unit (12) of claim 11, wherein a stator housing (15) of the electric motor (13) is flanged to the gear housing (18) by a flange (58), such that the rotor shaft (14) protrudes from the stator housing (15) into the gear housing (18).
